(19) United States
(12) Patent Application Publication
(10) Pub. No.: US 2015/0227167 A1
(43) Pub. Date: Aug. 13, 2015

(54) BACK COVER ASSEMBLY OF ELECTRONIC MOBILE DEVICE CAPABLE OF CONTROLLING LIGHT EMISSION EFFECT

(71) Applicant: Ming Yi CHIANG, New Taipei Hsien (TW)

(72) Inventor: Ming Yi CHIANG, New Taipei Hsien (TW)

(21) Appl. No.: 14/176,161

(22) Filed: Feb. 10, 2014

(51) Int. Cl. G06F 1/16; H04B 1/3888; H04M 1/02; F21V 8/00; G03B 15/02

(52) U.S. Cl. CPC G06F 1/1613; G02B 6/0075; G03B 15/02; G06F 1/1656; H04M 1/0202; H04B 1/3888

(57) ABSTRACT

A back cover assembly of an electronic mobile device capable of controlling light emission effect comprises a back cover combinable to an electronic mobile device; the back cover including a flash hole positioned to be corresponding to a light emitting device of the electronic mobile device; the flash hole causing light emitting from the electronic mobile device to emit outwards; and at least one light guide strip on a light guide area or on a periphery of the back cover for guiding light to the whole light guide area The light guide strip includes a flash contact section which serves to contact the light emitting from the flashlight from the electronic mobile device. The flash contact section is separable from other portion of the light guide strip. A light control unit serves for controlling separation or combination of the flash contact section with other portion of the light guide strip.

### FIELD OF THE INVENTION

The present invention relates to light effect to handsets, and in particular to a back cover assembly of an electronic mobile device capable of controlling light emission effect.

### BACKGROUND OF THE INVENTION

Currently, smart phones are more and more popular. Furthermore, many people take and look the handset all day long. As a result, more people take care of the outlook the handset. They desire that their handsets may have very attractive outlooks so as to induce the attractions from other people.

There are many novel designs and ways aiming at to cause the handsets can have very special outlooks. However, in these prior arts, they claim to the variations of the physical shapes. In current trend, back covers have gradually become basic equipments to be added to handset and the shapes of the back covers have kept the attractions to the owners of handsets. Presenting beautiful outlooks on the back cover is a new trend to the designers of handset additive equipments.

But as we know, handsets still have the function of light emission. Thus the inventor of this application desire to disclose a new design about the outlook of the handset which can present a very attractive outlook so as to present a pleasure effect to people and moreover, this attractive effect does not affect the original light function of the light source.

### SUMMARY OF THE INVENTION

Accordingly, the object of the present invention is to provide a back cover assembly of an electronic mobile device capable of controlling light emission effect, wherein whether the light is transferred to the light guide strip is controllable. By controlling the contact state between the flash contact section and light guide strip, the light from the light emitting device (such as a flashlight) of the electronic mobile device is controllable to be at a state of emitting light for predetermined usages or at a state of light transfer along the light guide strip so as to present a very beautiful outlook at the back cover.

To realize above mentioned advantage, the present invention provides a back cover assembly of an electronic mobile device capable of controlling light emission effect comprising: a back cover combinable to an electronic mobile device; the back cover having an inner side combinable to the electronic mobile device; the back cover including: a flash hole penetrating through the back cover and positioned to be corresponding to a light emitting device of the electronic mobile device; the flash hole causing light emitting from the electronic mobile device to emit outwards; and at least one light guide strip on a light guide area or on a periphery of the back cover for guiding light to the whole light guide area; the material of the light guide strip can guide light along the strip.

The back cover assembly further comprises a the light guide strip includes a flash contact section which serves to contact the light emitting from the flashlight from the electronic mobile device; and the flash contact section is separable from other portion of the light guide strip and a light control unit for controlling separation or combination of the flash contact section with other portion of the light guide strip.

### BRIEF DESCRIPTION OF THE DRAWINGS

FIG. 1A is a schematic view about the back cover of the present invention.

FIG. 1A is a schematic view about the light guide strip of the present invention.

FIG. 2 is a schematic view showing the application of the present invention, where the light guide strip of the present invention is in a conduction state.

FIG. 3 is a schematic view showing that the application in FIG. 2 is in a non-conduction state.

FIG. 4 is a backside view about the state shown in FIG. 3.

FIG. 5 shows the structure of the components in the first application of the present invention.

FIG. 6 is a schematic view showing the second application of the present invention, which is in a conduction state.

FIG. 7 is a schematic view showing the second application of the present invention, which is in a non-conduction state.

FIG. 8 is a backside view about the structure shown in FIG. 7.

FIG. 9 is a perspective view about the rotatable control unit of the present invention.

FIG. 10 is a structural view about the rotatable control unit and the flash contact section of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

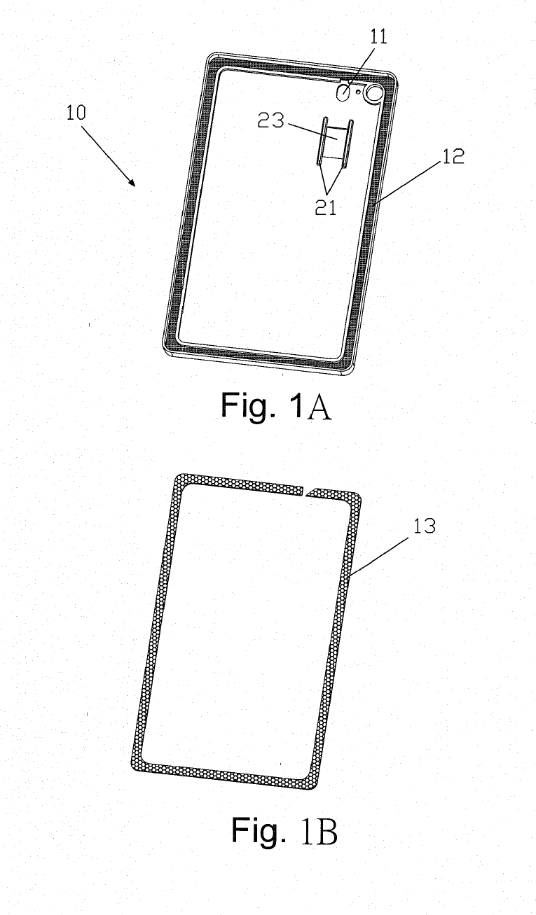

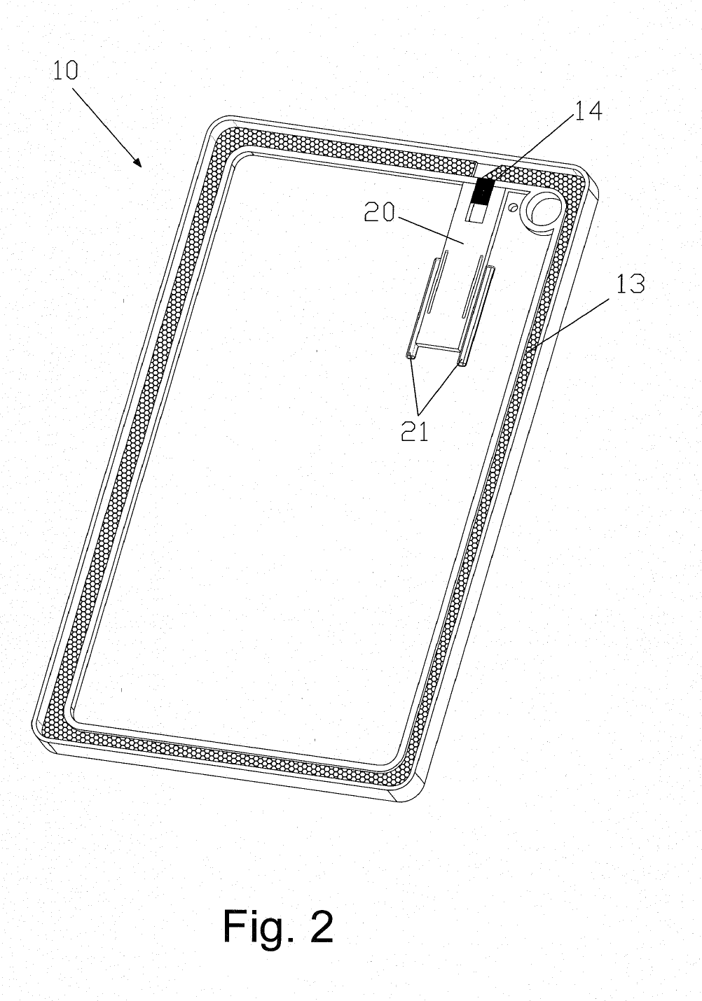

With reference to FIGS. 1A to 10, the structure of the present invention is illustrated. In FIGS. 1A, 1B, 2A and 2B, the back cover for an electronic mobile device with light emitting effect according to the present invention comprises the following elements.

A back cover 10 is combinable to an electronic mobile device. The back cover 10 has an inner side combinable to the electronic mobile device and an outer side at an opposite side of the inner side. The back cover 10 has a flash hole 11 penetrating through the back cover 10 and positioned to be corresponding to a lighting device (not shown), such as a flashlight, of the electronic mobile device. The flash hole 11 causes light emitting from the electronic mobile device to emit outwards.

The back cover 10 includes the following elements.

A light guide area 12 is a hollow area in the back cover 10 or a recessed area on the back cover 10.

The light guide area 12 is installed in the inner or outer side of the back cover 10 and can be formed as texts, drawings, marks or symbols, etc.

At least one light guide strip 13 is preferably on the light guide area 12 or on a periphery of the back cover 10 for guiding light to the whole light guide area 12. The material of the light guide strip 13 can guide light along the strip.

In another embodiment of the present invention, the light guide strip 13 includes a flash contact section 14 which serves to contact the light emitting from the flashlight from the electronic mobile device. The flash contact section 14 is separable from other portion of the light guide strip 13.

In a first embodiment of the present invention, the structure of the present invention further comprises the following elements.

A light control unit 20 serves for controlling separation or combination of the flash contact section 14 with other portion of the light guide strip 13.

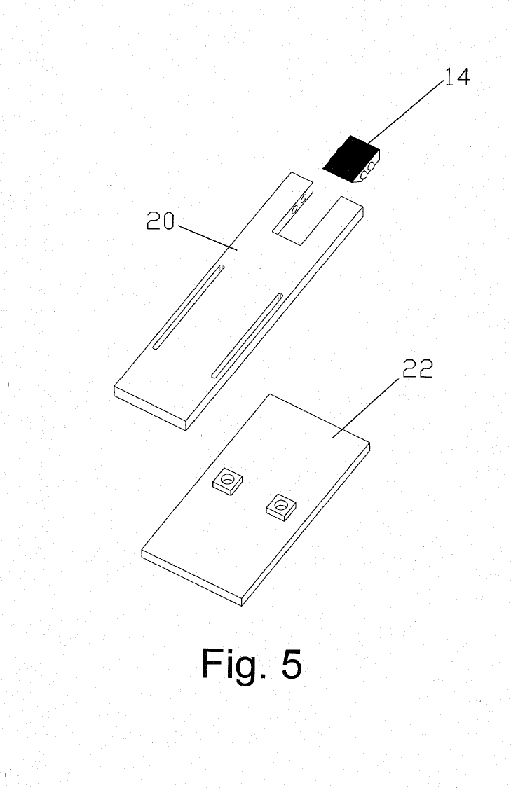

As illustrated in FIG. 2, the light control unit 20 is a thin object with a U shape recess at a front side thereof for receiving the flash contact section 14. A lateral side of the light control unit 20 has a buckle for combining the flash contact section 14 (referring to FIG. 5). The light control unit 20 is slidable along a track of the back cover 10. The flash contact section 14 is received in the U shape recess of the light control unit 20 so that movement of the light control unit 20 will drive the flash contact section 14 to move therewith to be combined to or separated from the other portion of the light guide strip 13. When the flash contact section 14 is combined to the other portion of the light guide strip 13, the light from the light emitting device of the electronic mobile device will transfer to the light guide strip 13 through the flash contact section 14 to the other portion of the light guide strip 13. When the flash contact section 14 is separated from the other portion of the light guide strip 13, the light emitted from the light emitting device of the electronic mobile device cannot be transferred to the light guide strip 13.

Preferably, the slide track at an inner side of the back cover 10 is formed by two protrusion strips 21 so that the light control unit 20 is slidably buckled with the two protrusion strips 21.

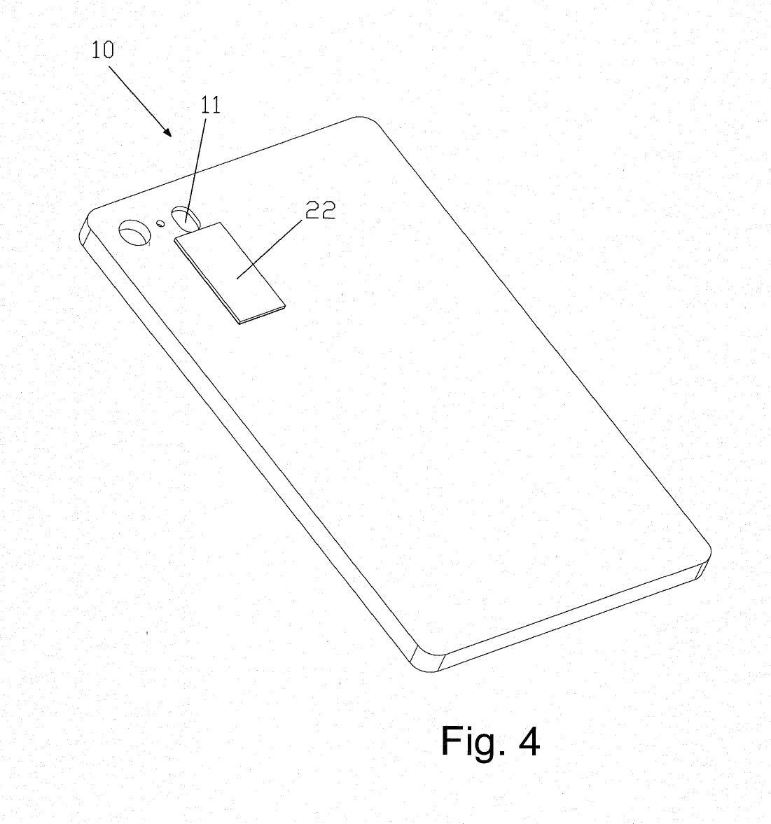

A push unit 22 is a sheet object and is adhered to an outer side of the back cover 10 (referring to FIG. 4) so that when the push unit 22 is pushed, the light control unit 20 is driven to move therewith.

In this embodiment, as illustrated in FIG. 1A and FIG. 5, the back cover 10 is formed with a penetrating hole 23 between the two protruding strips 21 at the inner side of the back cover 10 so that the push unit 22 can be combined to the light control unit 20 by using a combining unit (see FIG. 5) at one side of the push unit 22 and passing through the penetrating hole 23 to be combined to the light control unit 20. For example, the combining unit 22 is adhered to the light control unit 20 so as to combine the push unit 22 to the light control unit 20.

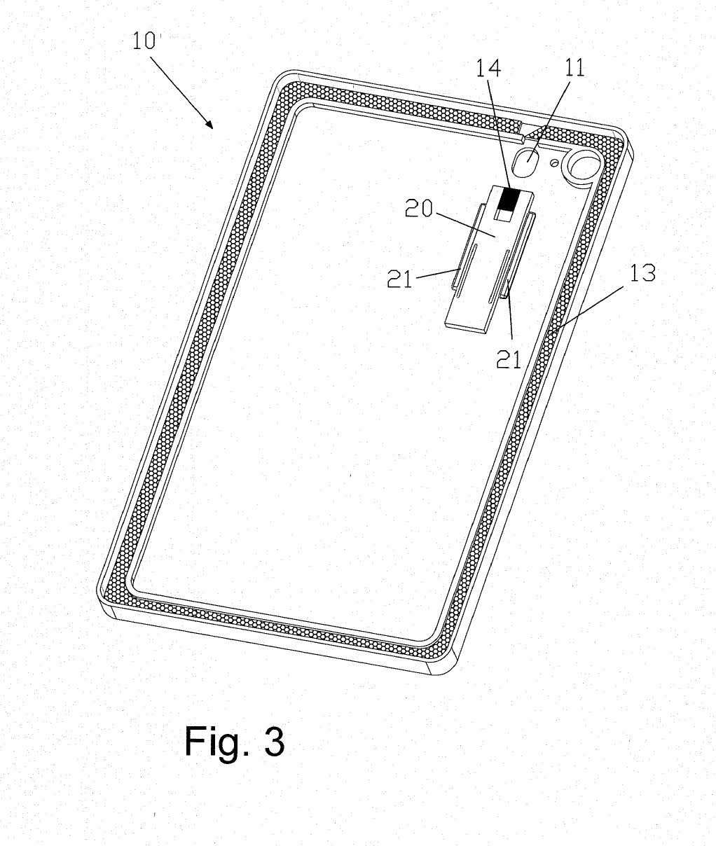

With reference to FIG. 2, in a conduction state, the flash contact section 14 is in contact with the other portion of the light guide strip 13. The flash contact section 14 will closely contact the light from the light emitting device of the electronic mobile device and thus guild light to the whole portion of the light guide strip 13. With reference to FIG. 3, in a non-conduction state, the flash contact section 14 is not in contact with the other portion of the light guide strip 13 and thus the flash contact section 14 will not contact the light from the light emitting device (such as the flashlight) of the electronic mobile device and thus no light is transferred to the light guide strip 13. Therefore, no light is transferred to the whole light guide strip 13.

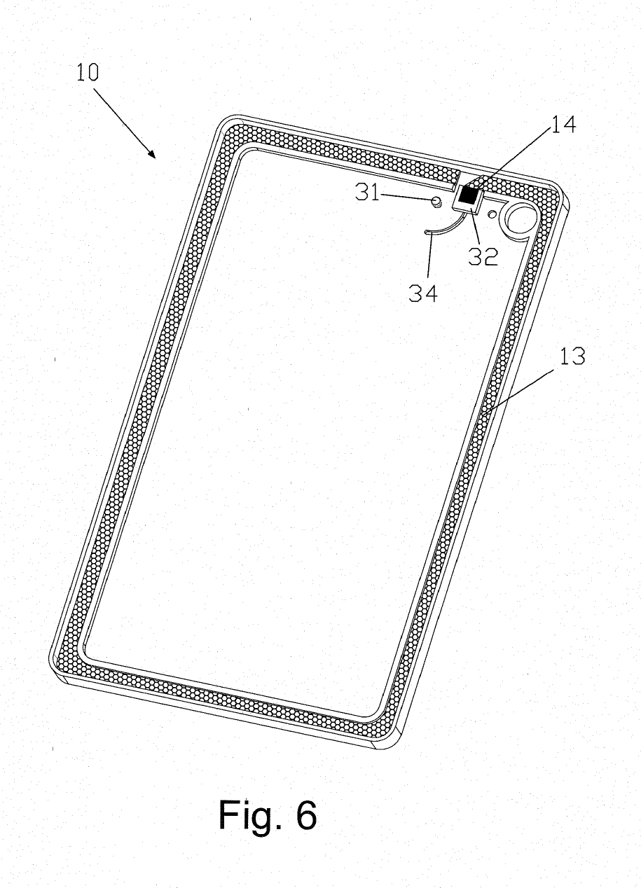

With reference to FIGS. 6 to 10, in that the second embodiment of the present invention is illustrated.

Referring to FIG. 9, a rotatable control unit 30 serves to control the separation or combination of the flash contact section 14 to the other portion of the light guide strip 13.

The rotatable control unit 30 includes a bottom plate 35. An inner side of the bottom plate 35 is adhered to the outer side of the back cover 10. The inner side of the bottom plate 35 is extended with a buckling protrusion 31 with a larger head far away from the bottom plate and a smaller distal end combined to the inner side of the rotatable control unit 30.

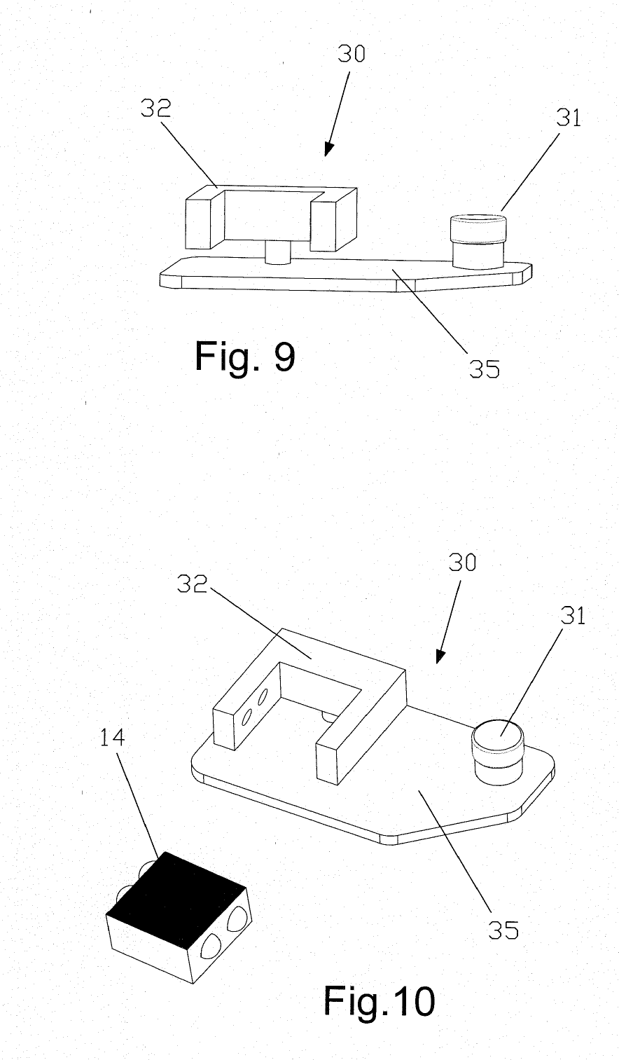

Another end of the inner side of the bottom plate 35 is extended with a bar which supports a U shape frame 32 for buckling and receiving the flash contact section 14, as illustrated in FIG. 10.

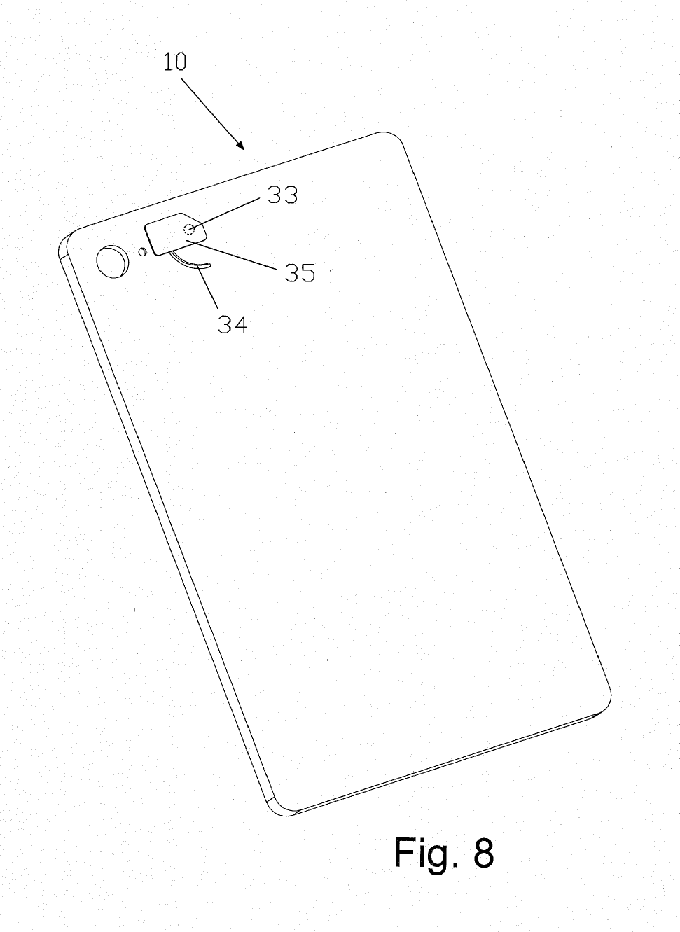

The back cover 10 has a pivot hole 34 (see FIG. 8) for receiving the buckling protrusion 31 of the rotatable control unit 30 so that the rotatable control unit 30 is pivotal to the back cover 10.

The back cover 10 further has a cambered hole 34 penetrating through the back cover 10. In installing state, the bar of the rotatable control unit 30 is movable along the cambered hole 34 of the back cover 10.

With reference to FIG. 8, the rotatable control unit 30 is buckled to the pivot hole 34 of the back cover 10 and the bar of the rotatable control unit 30 is received in the cambered hole 34 of the back cover 10. The rotatable control unit 30 is buckled to the pivot hole 33 of the back cover 10 (referring to FIG. 8). The rotatable control unit 30 is rotatable on the back cover 10 so as to control the flash contact section 14 to separate from or attached to the light guide strip 13. The rotatable control unit 30 serves control light from a light emitting device (such as a flashlight) of the electronic mobile device to transfer along the light guide strip 13.

With reference to FIG. 6, in conduction state, the light guide strip 13 contacts the flash contact section 14. As light emitted from the light emitting device of the electronic mobile device, it will transfer to the flash contact section 14 and then transfers along the light guide strip 13.

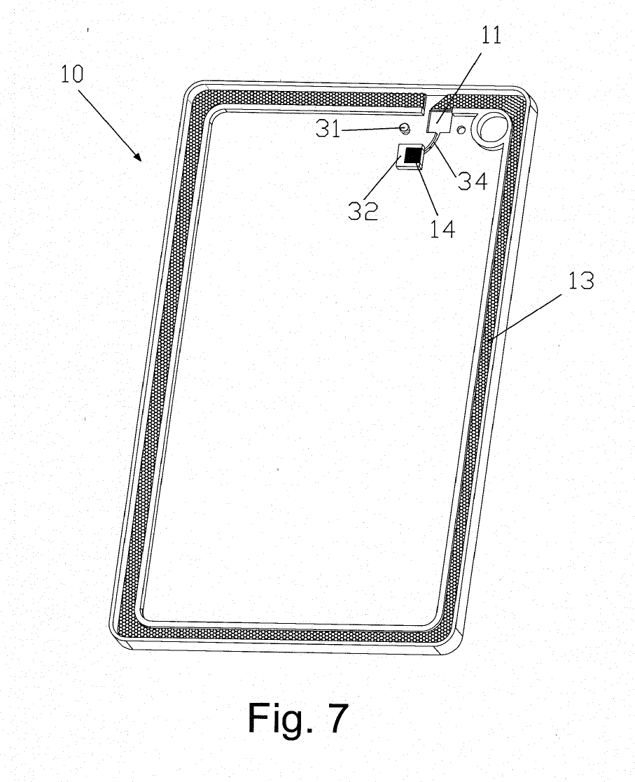

With reference to FIG. 7, in a non conduction state, the light guide strip 13 is separated from the flash contact section 14 and thus light from the flashlight of the electronic mobile device cannot transfer to the flash contact section 14 and thus not transfer to the light guide strip 13. The light will emit out

Advantages of the present invention are that whether the light is transferred to the light guide strip 13 is controllable. By controlling the contact state between the flash contact section 14 and light guide strip 13, the light from the light emitting device (such as a flashlight) of the electronic mobile device is controllable to be at a state of emitting light, for example as a flash light in taking photos, or at a state of light transfer along the light guide strip 13 so as to present a very beautiful outlook at the back cover.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A back cover assembly of an electronic mobile device capable of controlling light emission effect comprising:
a back cover combinable to an electronic mobile device; the back cover having an inner side combinable to the electronic mobile device; the back cover being formed with a flash hole penetrating through the back cover and positioned to be corresponding to a light emitting device of the electronic mobile device; the flash hole causing light emitting from the electronic mobile device to emit outwards; and
at least one light guide strip on a light guide area or on a periphery of the back cover for guiding light to the whole light guide area; and material of the light guide strip can guide light along the strip.

2. The back cover assembly of an electronic mobile device capable of controlling light emission effect as claimed in claim 1, wherein the light guide area is a hollow area in the back cover or a recessed area on the back cover; and the light guide area is formed in the inner or outer side of the back cover.

3. The back cover assembly of an electronic mobile device capable of controlling light emission effect as claimed in claim 2, wherein the light guide area is formed as texts, drawings, marks or symbols.

4. The back cover assembly of an electronic mobile device capable of controlling light emission effect as claimed in claim 1, wherein the light guide strip includes a flash contact section which serves to contact the light emitting from the flashlight from the electronic mobile device; and the flash contact section is separable from and attached to other portion of the light guide strip.

5. The back cover assembly of an electronic mobile device capable of controlling light emission effect as claimed in claim 4, further comprising: a light control unit for controlling separation or combination of the flash contact section with other portion of the light guide strip.

6. The back cover assembly of an electronic mobile device capable of controlling light emission effect as claimed in claim 5, wherein the light control unit is a thin object with a U shape recess at a front side thereof for receiving the flash contact section; a lateral side of the light control unit has a buckle for combining the flash contact section; the light control unit is slidable along a track of the back cover; the flash contact section is received in the U shape recess of the light control unit so that movement of the light control unit will drive the flash contact section to move therewith to be combined to or separated from the other portion of the light guide strip; when the flash contact section is combined to the other portion of the light guide strip, light from the light emitting device of the electronic mobile device will transfer to the light guide strip through the flash contact section to the other portion of the light guide strip; when the flash contact section is separated from the other portion of the light guide strip, and the light emitted from the light emitting device of the electronic mobile device cannot be transferred to the light guide strip.

7. The back, cover assembly of an electronic mobile device capable of controlling light emission effect as claimed in claim 6, wherein the slide track at an inner side of the back cover is formed by two protrusion strips so that the light control unit is slidably buckled with the two protrusion strips.

8. The back cover assembly of an electronic mobile device capable of controlling light emission effect as claimed in claim 7, further comprising:
a push unit being a sheet object and being adhered to an outer side of the back cover so that when the push unit is pushed, the light control unit is driven to move therewith; and the back cover being formed with a penetrating hole between the two protruding strips at the inner side of the back cover so that the push unit can be combined to the light control unit by using a combining unit at one side of the push unit and passing through the penetrating hole to be combined to the light control unit.

9. The back cover assembly of an electronic mobile device capable of controlling light emission effect as claimed in claim 5, wherein the light control unit being a rotatable control unit for controlling the separation or combination of the flash contact section to the other portion of the light guide strip.

10. The back cover assembly of an electronic mobile device capable of controlling light emission effect as claimed in claim 9, wherein the rotatable control unit including a bottom plate; an inner side of the bottom plate is adhered to the outer side of the back cover; an inner side of the bottom plate is extended with a buckling protrusion with a larger head far away from the rotatable control unit and a distal end combined to the inner side of the bottom plate; another end of the inner side of the bottom plate is extended with a bar which supports a U shape frame for buckling and receiving the flash contact section;
the back cover has a pivot hole for receiving the buckling protrusion of the rotatable control unit so that the rotatable control unit is pivotal to the back cover;
the back cover further has a cambered hole penetrating through the back cover; in installing state, the bar of the rotatable control unit is movable along the cambered hole of the back cover;
wherein the rotatable control unit is buckled to the pivot hole of the back cover and the bar of the rotatable control unit is received in the cambered hole of the back cover; the rotatable control unit is buckled to the pivot hole of the back cover; the rotatable control unit is rotatable on the back cover so as to control the flash contact section to separate from or attached to the light guide strip to control light from a light emitting device of the electronic mobile device to transfer along the light guide strip.
